(19) United States
(12) Patent Application Publication
(10) Pub. No.: US 2026/0226988 A1
(43) Pub. Date: Aug. 6, 2026

(54) OFFSET CONTROL STOP

(71) Applicant: Zurn Water, LLC, Milwaukee, WI (US)

(72) Inventors: Long Larry Le, Milwaukee, WI (US); Cody G. Cotton, Pittsboro, NC (US); Robert Carter, Holly Springs, NC (US); Jack Salay, Milwaukee, WI (US)

(21) Appl. No.: 19/457,852

(22) Filed: Jan. 23, 2026

Related U.S. Application Data
(60) Provisional application No. 63/749,335, filed on Jan. 24, 2025.

(51) Int. Cl. F16K 1/52; E03D 3/02; F16K 27/02

(52) U.S. Cl. CPC F16K 1/523; E03D 3/02; F16K 27/02

(57) ABSTRACT

An offset control stop includes a body, a flow chamber positioned within the body, a stop, an inlet port having an inlet axis, and an outlet port extending along an outlet axis at an angle relative to the inlet axis. The body includes a front wall, a rear wall opposite the front wall, and a side wall extending between the front wall and the rear wall. The stop is coupled to the front wall and extends into the flow chamber. The inlet port is configured to receive fluid from a water supply line and an outlet port. The outlet axis is vertically offset from the inlet port, and the outlet port providing fluid communication between the flow chamber and a flush valve.

### CROSS-REFERENCE TO RELATED APPLICATION

The present application claims the benefit of U.S. Provisional Patent Application No. 63/749,335, filed January 24, 2025. The entire contents of the aforementioned application is incorporated by reference herein.

### TECHNICAL FIELD

The present disclosure relates to control valve for providing fluid communication between a water supply line and a flushometer.

### BACKGROUND

In some constructions, an automatic flush valve may have a greater height than a traditional, manual diaphragm-based flush valve, which may complicate the installation of the supply line due to potential clearance issues with other components in a restroom (e.g., an ADA grab bar located above a water closet) and/or water supply line misalignment.

### SUMMARY

In one independent aspect, an offset control stop includes: a body including a front wall having a threaded opening, a rear wall opposite the front wall, and a side wall extending between the front wall and the rear wall; a flow chamber positioned within the body; a stop coupled to the threaded opening of the front wall, the stop extending into the flow chamber; an inlet port extending along an inlet axis, the inlet port configured to receive fluid from a water supply line; and an outlet port positioned adjacent to the side wall, the outlet port extending along an outlet axis oriented at an oblique angle relative to the inlet axis, the outlet axis being vertically offset from the inlet port, and the outlet port configured to provide fluid communication between the flow chamber and a flush valve.

In some aspects, the outlet port is a right-hand offset.

In some aspects, the outlet port is a left-hand offset.

In some aspects, the outlet port contains threads on an external surface of the outlet port.

In some aspects, the inlet port contains threads on an internal surface of the inlet port.

In some aspects, the stop includes a seal that engages with a sealing surface of the threaded opening of the front wall.

In some aspects, the stop engages the seal with the sealing surface to stop the flow of fluid through the flow chamber.

In some aspects, the stop disengages the seal with the sealing surface to allow the flow of fluid through the flow chamber.

In some aspects, the outlet port is 1.5 inches lower than the inlet port.

In another independent aspects, an offset control stop includes: a body includes a front wall having a threaded opening, a rear wall opposite the front wall, a side wall extending between the front wall and the rear wall, and a flow chamber positioned within the body; a stop coupled to the threaded opening of the front wall, the stop extending into the flow chamber, the stop having a seal engaging a sealing surface of the threaded opening of the front wall; an inlet port positioned adjacent the rear wall of the body, the inlet port extending along an inlet axis, the inlet port configured to receive fluid from a water supply line; and an outlet port extending along an outlet axis and positioned adjacent to the side wall of the body, the outlet axis oriented at an oblique angle relative to the inlet axis and vertically offset from the inlet port, the outlet port configured to provide fluid communication between the flow chamber and a flush valve.

In some aspects, wherein the outlet port is a right-hand offset.

In some aspects, the outlet port is a left-hand offset.

In some aspects, the outlet port contains threads on an external surface of the outlet port.

In some aspects, the inlet port contains threads on an internal surface of the inlet port.

In some aspects, the stop engages the seal with the sealing surface to stop the flow of fluid through the flow chamber.

In some aspects, the stop disengages the seal with the sealing surface to allow the flow of fluid through the flow chamber.

In some aspects, the outlet port is 1.5 inches lower than the inlet port.

In yet another independent aspects, an offset control stop includes: a body including a front wall, a rear wall opposite the front wall, a side wall extending between the front wall and the rear wall, and a flow chamber positioned within the body; a stop coupled to the front wall, wherein the stop extends into the flow chamber; an inlet port having an inlet axis, wherein the inlet port is configured to receive fluid from a water supply line and an outlet port; and an outlet port extending along an outlet axis at an angle relative to the inlet axis, the outlet axis vertically offset from the inlet port, the outlet port providing fluid communication between the flow chamber and a flush valve.

In some aspects, the stop disengages the seal with the sealing surface to allow the flow of fluid through the flow chamber.

In some aspects, the outlet port is 1.5 inches lower than the inlet port.

### BRIEF DESCRIPTION OF THE DRAWINGS

FIG. 1A is a perspective view of an offset control stop.

FIG. 1B is an exploded view of the offset control stop of FIG. 1A.

FIG. 2 is a front view of the offset control stop of FIG. 1A.

FIG. 3 is a cross-sectional view of the control stop of FIG. 1A, viewed along section 3—3.

FIG. 4 is a rear view of the offset control stop of FIG. 1A.

FIG. 5 is a first side view of the offset control stop of FIG. 1A.

FIG. 6 is a second side view of the offset control stop of FIG. 1A.

FIG. 7 is a cross-sectional view of a body of the offset control stop of FIG. 1B, viewed along section 7—7.

FIG. 8 is a cross-sectional view of the offset control stop of FIG. 1A, viewed along section 8—8.

FIG. 9 is a cross-sectional view of the offset control stop of FIG. 1A, viewed along section 9—9.

FIG. 10 is a perspective view of a offset control stop according to another embodiment.

FIG. 11 is a front view of the offset control stop of FIG. 10.

FIG. 12 is a cross-sectional view of the control stop of FIG. 10, viewed along section 12—12.

FIG. 13 is rear view of the offset control stop of FIG. 10.

FIG. 14 is a first side view of the offset control stop of FIG. 10.

FIG. 15 is a second side view of the offset control stop of FIG. 10.

FIG. 16 is a cross-sectional view of the offset control stop of FIG. 10 with a valve member removed, viewed along section 18—18.

FIG. 17 is a cross-sectional view of the offset control stop of FIG. 10, viewed along section 17—17.

FIG. 18 is a cross-sectional view of the offset control stop of FIG. 10, viewed along section 18—18.

FIG. 19 is a flow diagram of a method for connecting an offset control stop to a flushometer and activating and deactivating the stop mechanism.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the disclosure relates to an offset control stop that provides versatility during installation of plumbing fixtures and mitigates potential interference. The offset control stop provides additional clearance in an area near a water closet or a toilet (e.g., around an ADA grab bar). The offset control stop may adjust a position of the supply line to aid in installation. For example, the adjustment may lower the height of the supply line. The offset control stop may provide a left-hand offset or a right-hand offset.

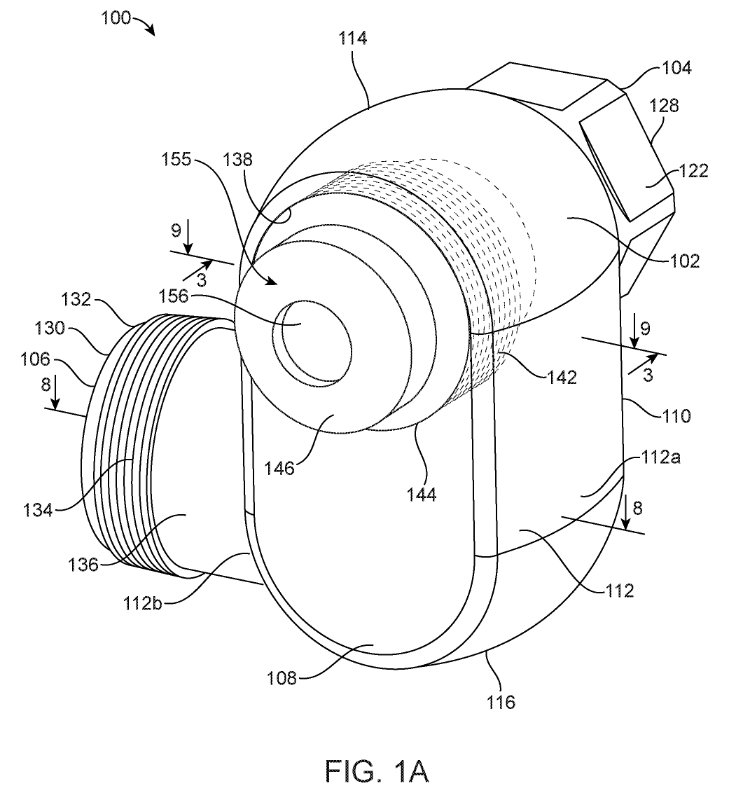

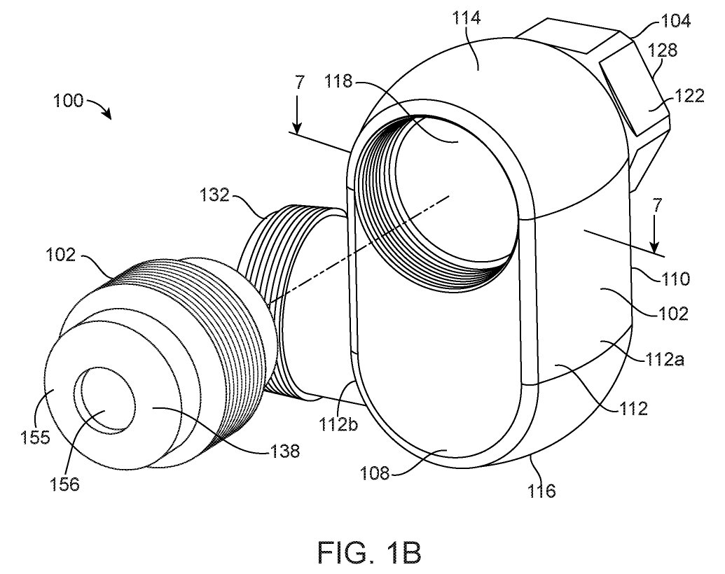

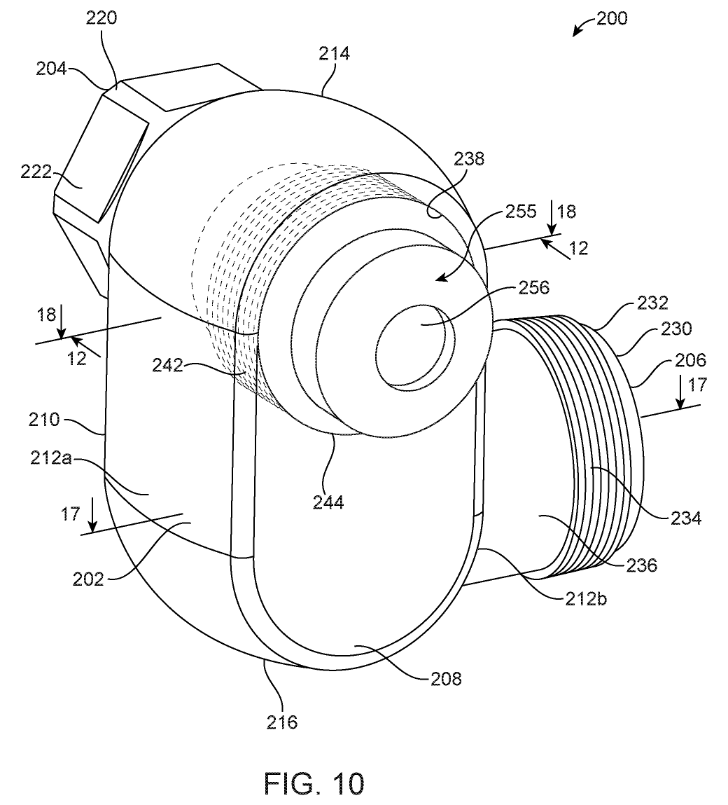

FIGS. 1A through 8 show a control valve (e.g., a control stop 100) that includes a body 102, an inlet port 104, and an outlet port 106. The control stop 100 may be constructed such that the outlet port 106 extends laterally to the left of the body 102 as viewed from the a front of the body 102 (e.g., a left-hand control stop, as shown in FIG. 1A) or extends laterally to the right of the body 102 as viewed from a front of the body 102 (e.g., a right-hand control stop, as shown in FIG. 10). A valve 155 is coupled to the body 102.

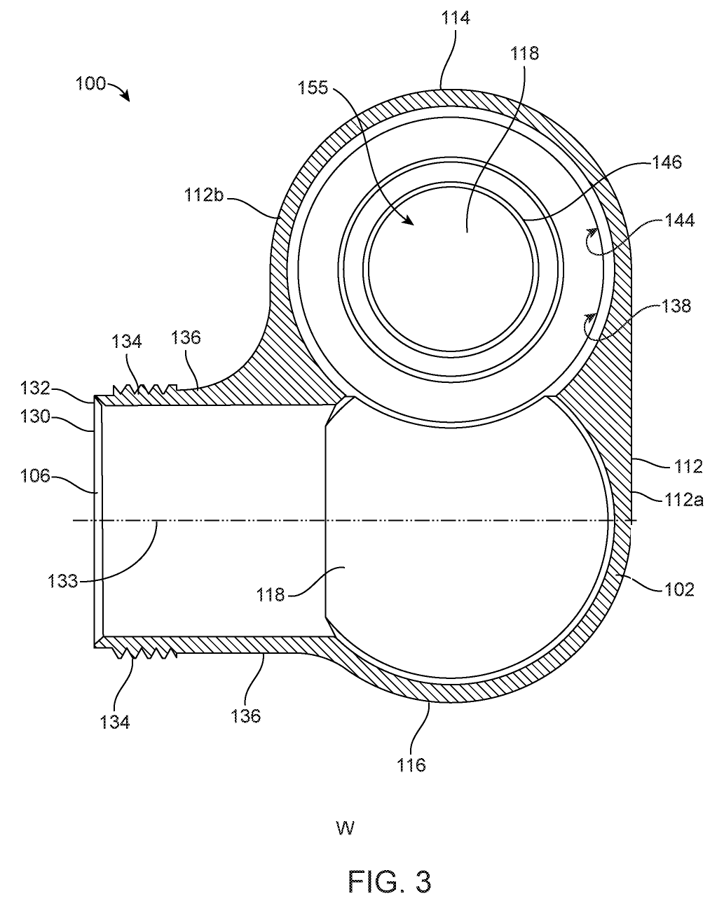

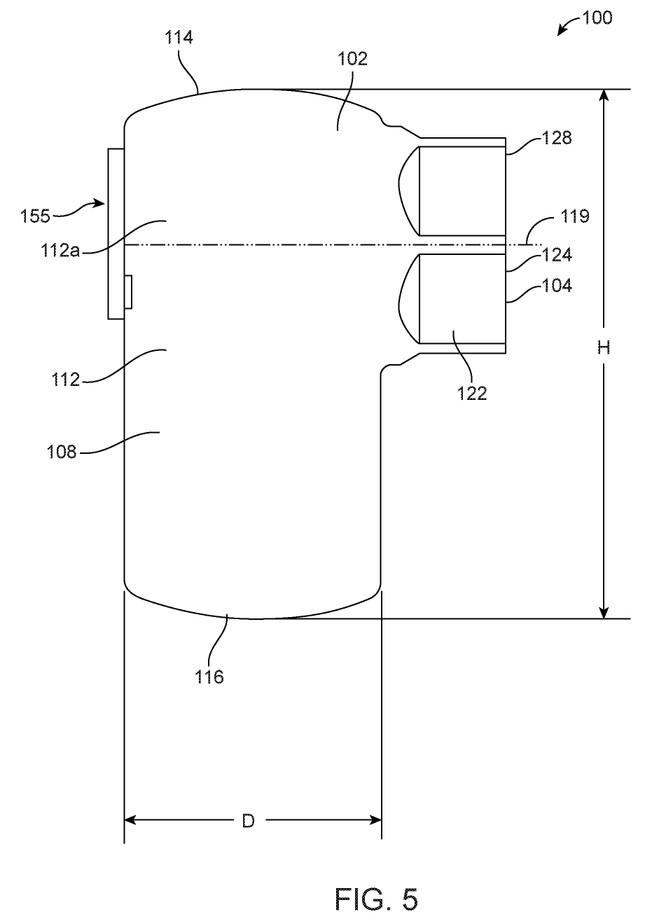

In the illustrated embodiment, the body 102 has a front wall 108, a rear wall 110, a side wall 112, a top end 114, and a bottom end 116. A flow chamber 118 (FIG. 1B) is positioned within the body 102. In some embodiments, a total width W (FIG. 3) of the body 102 including the offset outlet port may be nominally 3.20 inches. A depth D (FIG. 5) of the body 102 between the rear wall 110 and the front wall 108 may be nominally 1.76 inches. A height H (FIG. 5) of the body 102 from the top end 114 and the bottom end 116 is nominally 3.66 inches. In some instances, the body 102 may be, but is not limited to, chrome plated, brushed nickel, or matte black. In another instance, the body 102 may be a machined part that is first molded from a metal material, such as brass, and then machined to conform to the final shape.

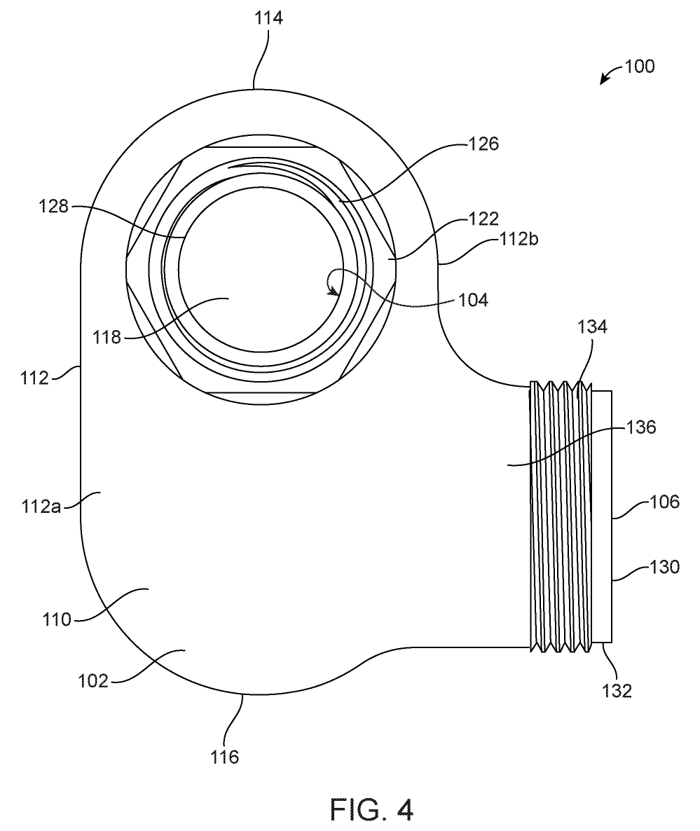

As shown in FIG. 1A, the inlet port 104 sits on the rear wall 110 near the top end 114 of the body 102. The inlet port 104 extends along an inlet axis 119 (shown in FIG. 5). The inlet port 104 seals around the inlet pipe from the flushometer using a nut 122. The inlet port 104 contains a threaded opening 124 (FIG. 4) for connecting with the inlet pipe of the flushometer. The inlet port is configured to receive fluid from a water supply line.

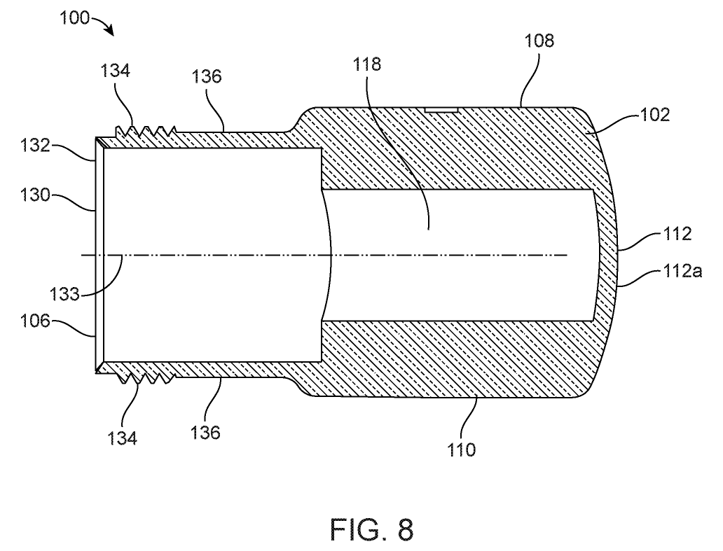

As shown in FIG. 1B, the outlet port 106 sits on the side wall 112 near the bottom end 116 of the body 102. The outlet port 106 contains a threaded opening 130 for connecting with an outlet pipe of the flushometer. In one instance, a rim 132 of the outlet port 106 may have a beveled edge. In yet other instances, the rim 132 of the outlet port 106 may have a rounded or square edge. The outlet port 106 extends along an outlet axis 133 (shown in FIGS. 3 and 8). The outlet port 106 contains threads 134 on the external surface 136 of the threaded opening 130 of the outlet port 106. In one instance, the outlet port 106 may be a left-hand outlet port as shown in FIGS. 1 through 9. In another instance, the outlet port may be a right-hand outlet port as discussed later in FIGS. 10 through 18. The outlet port 106 may create a 90-degree angle from the side wall 112 of the body 102. The center of the outlet port 106 may be offset 1.500 inches lower than the center of the inlet port 104. The outlet axis 133 oriented at an oblique angle relative to the inlet axis 119 and vertically offset from the inlet port. The outlet port 106 configured to provide fluid communication between the flow chamber 118 and a flush valve of a flushometer.

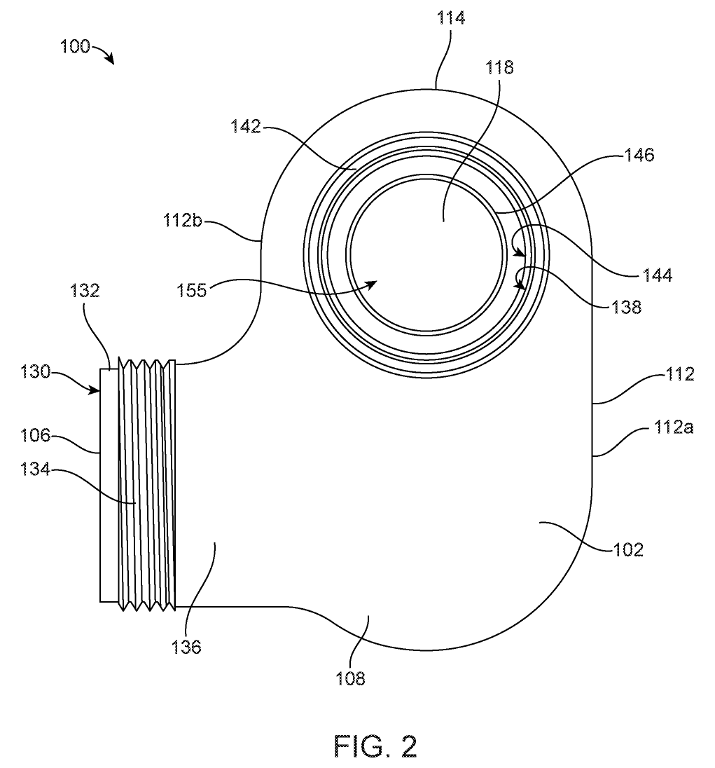

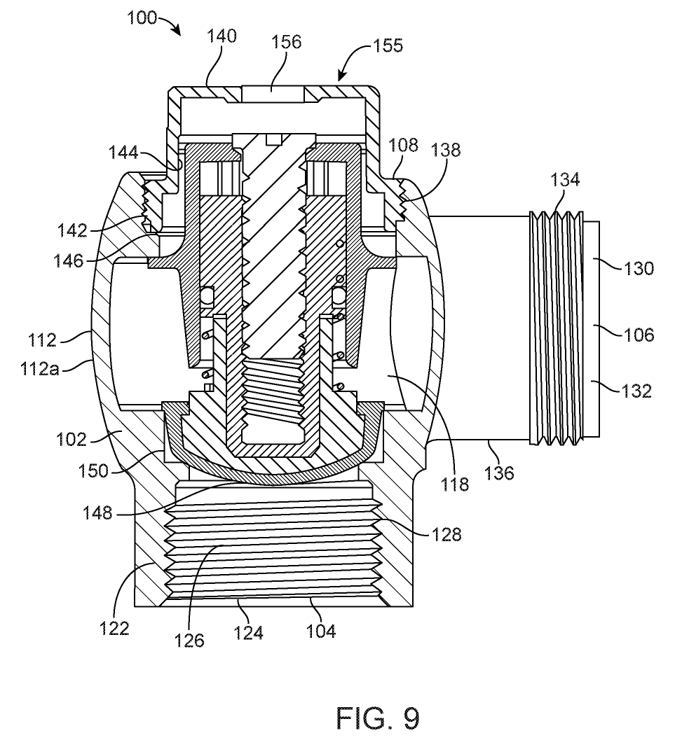

Referring again to FIG. 1B, the front wall 108 may be substantially planar (e.g., flat). In other embodiments, the front wall 108 may have other shapes, such as convex or concave. The front wall 108 contains a threaded opening 138 for receiving a stop mechanism 140 (shown in FIG. 9). The threaded opening 138 contains threads 142 on the internal surface 144 of the threaded opening 138. The threaded opening 138 on the front wall 108 has a sealing surface 146 (shown in FIG. 2) that meets with a seal 148 (also shown in FIG. 2) of the stop mechanism 140. The sealing surface 146 may be smooth and free from any tool markings.

In some embodiments, the rear wall 110 may be substantially planar. In other embodiments, the rear wall 110 may have other shapes, such as convex or concave. The rear wall 110 contains the protruding threaded opening 124 for the inlet port 104 for connecting with an inlet pipe of a flushometer. The rear wall 110 is positioned opposite the front wall 108.

The side wall 112 extends between the front wall 108 and the rear wall 110. The side wall 112 extends from the top end 114 to the bottom end 116 of the body 102. The side wall 112 connects the front wall 108 to the rear wall 110. In some instances, the side wall 112 may be substantially round and convex in shape. In other instances, the side wall 112 may be substantially planar between the front wall and the rea. In one instance, the body 102 may be substantially oval in shape with rounded edges where the side wall 112 meets the front wall 108 on the top end 114, the bottom end 116, a first side 112a and a second side 112b. In yet other instances, the body 102 may be other shapes such as square. In one instance, the body 102 may be substantially square in shape with near 90-degree edges where the side wall 112 meets the front wall 108 on the top end 114, the bottom end 116, the first side 112a and the second side 112b. Further, the edges may be near 90 degrees where the side wall 112 meets the rear wall 110 on the top end 114, the bottom end 116, the first side 112a and the second side 112b. Further, in one instance, the edges may be rounded where the side wall 112 meets the rear wall 110 on the top end 114, the bottom end 116, the first side 112a and the second side 112b. Yet, in other instances, the edges may be either beveled, tapered, or squared where the side wall 112 meets the rear wall 110 on the top end 114, the bottom end 116, the first side 112a and the second side 112b. The front wall 108, the rear wall 110, and the side wall 112 may have a uniform thickness.

The flow chamber 118 lies within the body 102 connecting the inlet port 104, the outlet port 106, and the threaded opening 138. The offset control stop 100 may be subject to a nominal operating pressure range. In some embodiments, the nominal operating pressure may be between about 25 psi to about 125 psi.

As best shown in FIGS. 1A and 1B, a valve 155 is removably coupled (e.g., threadably coupled) to the body 102. When coupled to the body 102, the valve 155 is positioned in the flow chamber 118.

FIG. 2 shows the offset control stop 100 including the body 102 and an outlet port 106 of FIG. 1A. The body 102 includes the front wall 108, the side wall 112, the top end 114, and the bottom end 116. The outlet port 106 includes the threaded opening 130, the rim 132, and threads 134 on the external surface 136 of the threaded opening 130. The outlet port 106 is offset 1.5 inches lower than the center of the threaded opening 138 of the front wall 108. Additionally, the outlet port 106 is a left-hand offset positioned on a second side 112b of side wall 112. The front wall 108 includes the threaded opening 138 for receiving the stop mechanism 140. The threaded opening 138 includes the threads 142 on the internal surface 144. The body 102 includes a flow chamber 118 connecting the outlet port 106, inlet port 104 and threaded opening 138.

FIG. 3 shows a left-hand offset control stop of FIG. 1A and similarly demonstrates the components described for FIG. 2. FIG. 3 also shows where the outlet port 106 extends along the outlet axis 133.

FIG. 4 shows the left-hand offset control stop of FIG. 1A, which includes the body 102, an inlet port 104 and an outlet port 106. The body 102 includes the front wall 108, the rear wall 110, the side wall 112, the top end 114, and the bottom end 116. The inlet port 104 includes a threaded opening 124 for receiving the inlet pipe from the flushometer. The inlet port 104 further includes threads 126 (FIG. 4) on the internal surface 128 of the threaded opening 124. The inlet port 104 forms a seal with the inlet pipe by the tightening mechanism of the nut 122.

The outlet port 106 of FIG. 4 includes the threaded opening 130, the rim 132, threads 134 on the external surface 136 of the threaded opening 130. The outlet port 106 is offset 1.5 inches lower than the center of the threaded opening 138 of the front wall 108. Additionally, the outlet port 106 is a left-hand offset positioned on a first side 112a of side wall 112. The body 102 includes a flow chamber 118 connecting the inlet port 104 and outlet port 106.

FIG. 5 shows the left-hand offset control stop 100 of FIG. 1A, which includes a body 102 and an inlet port 104. The body 102 includes the front wall 108, the rear wall 110, the side

wall 112, the top end 114, and the bottom end 116. The inlet port 104 includes the threaded opening 124 for receiving the inlet pipe from the flushometer. The inlet port 104 further includes threads 126 on the internal surface 128 of the threaded opening 124. The inlet port 104 forms a seal with the inlet pipe by the tightening mechanism of the nut 122.

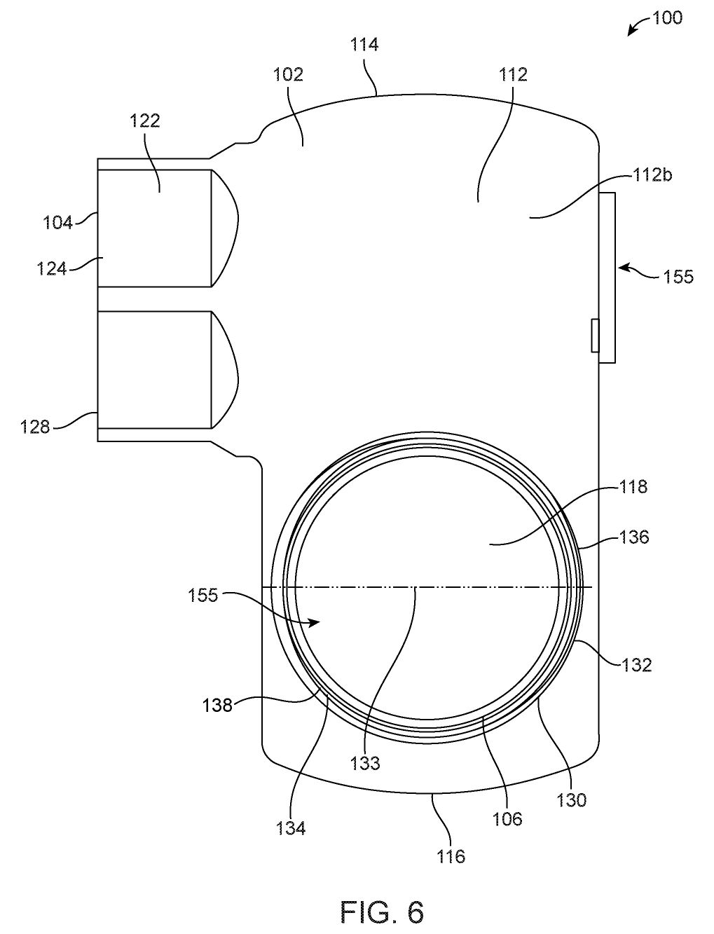

FIG. 6 shows the left-hand offset control stop 100 of FIG. 1A, which includes a body 102, the inlet port 104, and the outlet port 106. The body 102 includes the front wall 108, the rear wall 110, the side wall 112, the top end 114, and the bottom end 116. The inlet port 104 includes the threaded opening 124 for receiving the inlet pipe from the flushometer. The inlet port 104 further includes threads 126 on the internal surface 128 of the threaded opening 124. The inlet port forms a seal with the inlet pipe by the tightening mechanism of the nut 122. The outlet port 106 of FIG. 6 includes the threaded opening 130, the rim 132, and threads 134 on the external surface 136 of the threaded opening 130. In the illustrated embodiment, the outlet port 106 is offset 1.5 inches lower than the center of the threaded opening 138 of the front wall 108. Additionally, the outlet port 106 is a left-hand offset positioned on a first side 112a of side wall 112. The body 102 includes a flow chamber 118 connecting the inlet port 104 and outlet port 106.

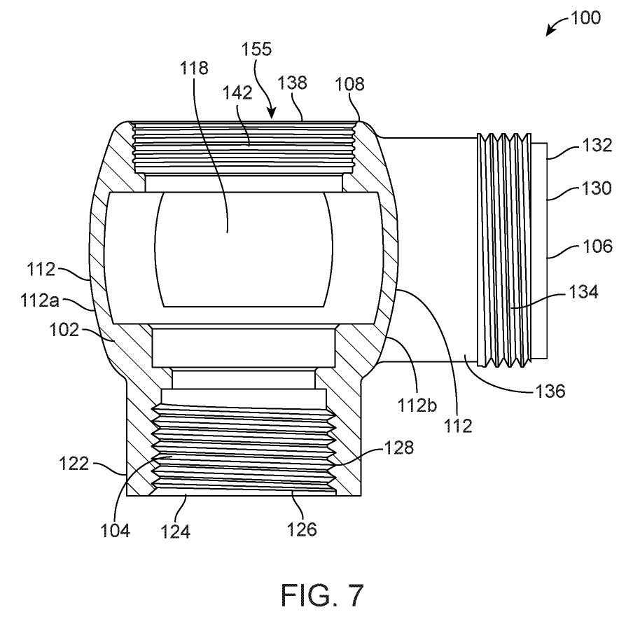

FIG. 7 shows the offset control stop 100, which includes the body 102, inlet port 104, an outlet port 106 and threaded opening 138 of FIG. 1A. The body 102 includes the front wall 108, the side wall 112, the top end 114, and the bottom end 116. The outlet port 106 includes the threaded opening 130, the rim 132, threads 134 on the external surface 136 of the threaded opening 130. The outlet port 106 is offset 1.5 inches lower than the center of the threaded opening 138 of the front wall 108. Additionally, the outlet port 106 is a left-hand offset positioned on a second side 112b of side wall 112. The front wall 108 includes the threaded opening 138 for receiving the stop mechanism 140. The threaded opening 138 includes the threads 142 on the internal surface 144. The threaded opening 138 further includes a sealing surface 146 to meet with the seal 148 of the stop mechanism 140. The body 102 includes a flow chamber 118 connecting the inlet port 104, outlet port 106, and threaded opening 138.

FIG. 8 shows the offset control stop 100, which includes the body 102 and outlet port 106 of FIG. 1A. The body 102 includes the front wall 108, the rear wall 110, and the side wall 112. The outlet port 106 includes the threaded opening 130, the rim 132, threads 134 on the external surface 136 of the threaded opening 130. The outlet port 106 is offset 1.5 inches lower than the center of the threaded opening 138 of the front wall 108. Additionally, the outlet port 106 is a left-hand offset positioned on a second side 112b of side wall 112. FIG. 8 also depicts the outlet axis 133 as extending through a center of the threaded opening 130.

FIG. 9 shows the left-hand offset control stop of FIGS. 1 through 8 with the stop mechanism 140 installed. The stop mechanism 140 contains a seal 148 that is engageable with a valve seat 150. The seal 148 has a convex, non-planar shape. The seal 148 acts to form a tight seal, stopping the flow of fluids in the flow chamber 118. When the stop mechanism 140 is activated, the seal 148 is engaged with the valve seat 150 and the fluid will not flow through the flow chamber 118. When the stop mechanism 140 is deactivated, the seal 148 is disengaged from the valve seat 150 and the fluid will flow through the flow chamber 118. In one instance, the flushometer may be triggered to begin a flush cycle by receiving a signal for a pre-scheduled activity. In another instance, the flushometer may be triggered to begin a flush cycle by receiving a signal from the flushometer’s motion sensor that may detect a user’s proximity to the flushometer. Thus, when the flushometer is triggered to begin a flush cycle, the stop mechanism 140 will be deactivated, the seal 148 disengaging from the valve seat 150 and allowing the fluid to flow through the flow chamber 118. In other words, the threaded opening 138 may further include a sealing surface 146 engaging the seal 148 of the stop mechanism 140.

As shown in FIG. 9, when the flushometer is in a waiting stage, such as when a user is detected to be within range of the flushometer’s motion sensor, the stop mechanism 140 will be activated, engaging the seal 148 with the valve seat 150 and stopping the flow of fluid through the flow chamber 118. When the user moves out of range of the flushometer’s motion sensor triggering the flushometer stop mechanism 140 to be deactivated, disengaging the seal 148 from the valve seat 150 and allowing fluid to flow through the flow chamber 118. In another instance, the flushometer may be in a waiting stage, such as for prolonged periods of not being used, the stop mechanism 140 will be activated, engaging the seal 148 with the valve seat 150 and stopping the flow of fluid through the flow chamber 118 until a signal is detected from a pre-scheduled activity, such as a pre-scheduled flush, triggering the stop mechanism 140 to be deactivated, disengaging the seal 148 from the valve seat 150 and allowing fluid to flow through the flow chamber 118.

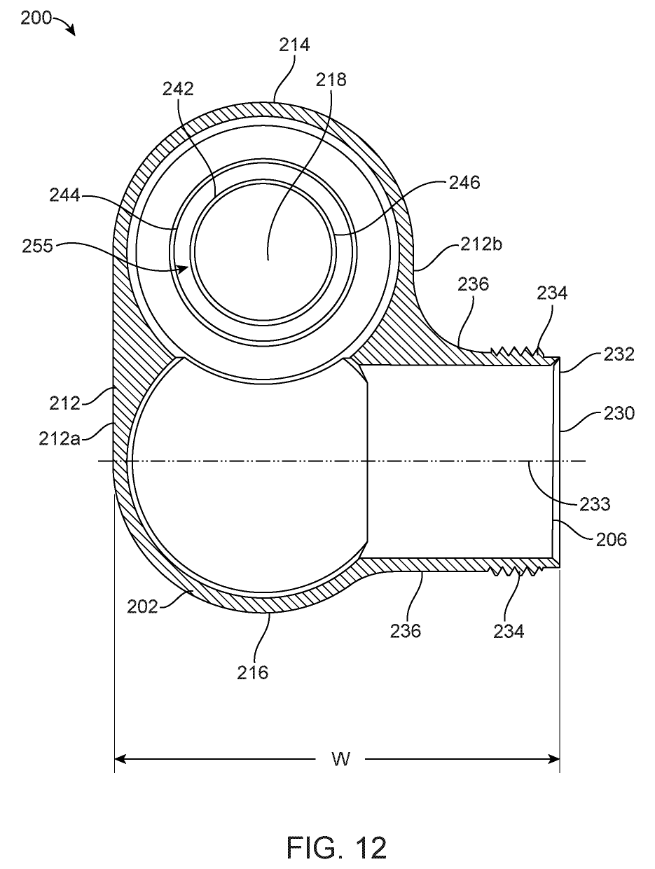

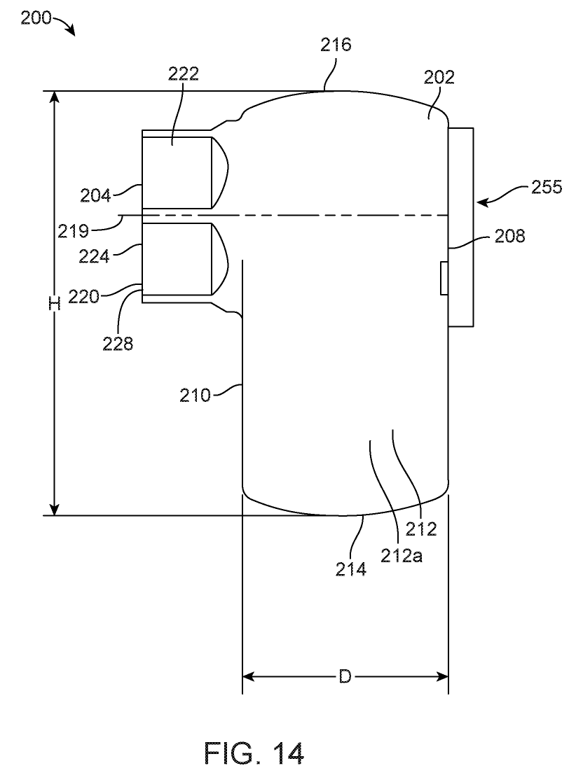

FIGS. 10 through 17 show a control valve (e.g., a control stop 200) that includes a body 202, an inlet port 204, and an outlet port 206. The control stop may be constructed such that the outlet port 206 extends laterally to the left of the body 202 (e.g., a left-hand control stop, as shown in FIG. 1A) or extends laterally to the right of the body 202 (e.g., a right-hand control stop, as shown in FIG. 10). In the illustrated embodiment, the body 202 has a front wall 208, a rear wall 210, a side wall 212, a top end 214 and a bottom end 216. A flow chamber 218 (FIG. 12) is positioned within the body 202. In some embodiments, a total width W of the body 202 including the offset outlet port may be nominally 3.20 inches (see FIG. 14). A depth D of the body 202 between the rear wall 210 and the front wall 208 may be nominally 1.76 inches (see FIG. 14). A total height H of the body 202 from the top end 214 and the bottom end 216 is nominally 3.66 inches. In some instances, the body 202 may be, but is not limited to, chrome plated, brushed nickel, or matte black. In another instance, the body 202 may be a machined part that is first molded from a metal material, such as brass, and then machined to conform to the final shape.

In FIG. 10, the inlet port 204 sits on the rear wall 210 near the top end 214 of the body 202. The inlet port 204 extends along an inlet axis 219 (shown in FIG. 14) to the rim 220. The inlet port 204 seals around the inlet pipe from the flushometer using a nut 222. The inlet port 204 contains a threaded opening 224 for connecting with the inlet pipe of the flushometer. The inlet port 204 contains threads 226 on the internal surface 228 of the threaded opening 224 of the inlet port 204. The inlet port 204 is configured to receive fluid from a water supply line.

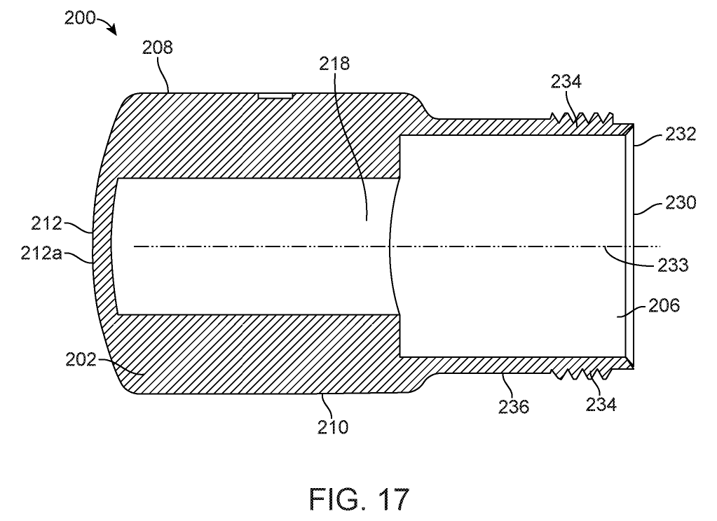

The outlet port 206 sits on the side wall 212 near the bottom end 216 of the body 202. The outlet port 206 contains a threaded opening 230 for connecting with an outlet pipe of the flushometer. In one instance, a rim 232 of the outlet port 206 may have a beveled edge. In other instances, the rim 232 of the outlet port 206 may have a rounded or square edge. The outlet port 206 extends along an outlet axis 233 (shown in FIGS. 12 and 17). The outlet port 206 contains threads 234 on the external surface 236 of the threaded opening 230 of the outlet port 206. The threads 234 stretch along the edge from the rim 232 of the outlet port 206. In one instance, the outlet port 206 may be a left-hand outlet port as shown in FIGS. 1 through 9. In another instance, the outlet port may be a right-hand outlet port as shown in FIGS. 10 through 18. The outlet port 206 may create a 90-degree angle from the side wall 212 of the body 202. The center of the outlet port 206 may be offset nominally 1.500 inches lower than the center of the inlet port 204. The outlet axis 233 oriented at an oblique angle relative to the inlet axis 219 and vertically offset from the inlet port. The outlet port 206 configured to provide fluid communication between the flow chamber 218 and a flush valve of a flushometer.

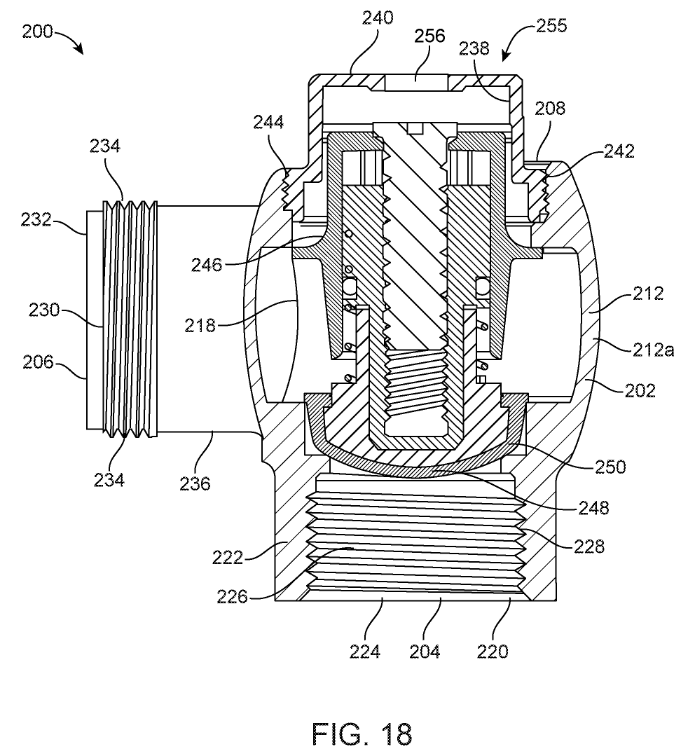

As shown in FIG. 10, the front wall 208 may be substantially planar. In other instances, the front wall 208 may have other shapes, such as convex or concave. The front wall 208 contains a threaded opening 238 for receiving a stop mechanism 240 (shown in FIG. 18). The threaded opening 238 contains threads 242 on the internal surface 244 of the threaded opening 238. The threaded opening 238 on the front wall 208 has a sealing surface 246 that meets with a seal 248 of the stop mechanism 240. The sealing surface 246 may be smooth and free from any tool markings.

In some embodiments, the rear wall 210 may be substantially planar. In other embodiments, the rear wall 210 may have a different shape (e.g., convex or concave). The rear wall 210 contains the protruding threaded opening 224 for the inlet port 204 for connecting with an inlet pipe of a flushometer. The rear wall 210 is positioned opposite the front wall 208.

The side wall 212 extends between the front wall 208 and the rear wall 210. The side wall 212 extends from the top end 214 to the bottom end 216 of the body 202. The side wall 212 connects the front wall 208 to the rear wall 210. In some instances, the side wall 212 may be substantially round and convex in shape with a radius of 2.15 inches with a tolerance of ±0.02 inches. In other instances, the side wall 212 may be substantially planar. In one instance, the body 202 may be substantially oval in shape with rounded edges where the side wall 212 meets the front wall 208 on the top end 214, the bottom end 216, a first side 212a and a second side 212b. In yet other instances, the body 202 may be other shapes such as square. In other instances, the body 202 may be substantially square in shape with near 90-degree edges where the side wall 212 meets the front wall 208 on the top end 214, the bottom end 216, the first side 212a and the second side 212b. Further, the edges may be near 90 degrees where the side wall 212 meets the rear wall 210 on the top end 214, the bottom end 216, the first side 212a and the second side 212b. Further, in one instance, the edges may be rounded where the side wall 212 meets the rear wall 210 on the top end 214, the bottom end 216, the first side 212a and the second side 212b. Yet, in other instances, the edges may be either beveled, tapered, or squared where the side wall 212 meets the rear wall 210 on the top end 214, the bottom end 216, the first side 212a and the second side 212b. The front wall 208, the rear wall 210, and the side wall 212 may have a uniform thickness.

In FIG. 10, the flow chamber 218 lies within the body 202 connecting the inlet port 204, the outlet port 206, and the threaded opening 238. A valve 255 is positioned in (e.g., removably coupled to) the threaded opening 238. The offset control stop 200 may be subject to a nominal operating pressure range. In some embodiments, the nominal operating pressure may be between about 25 psi to about 125 psi.

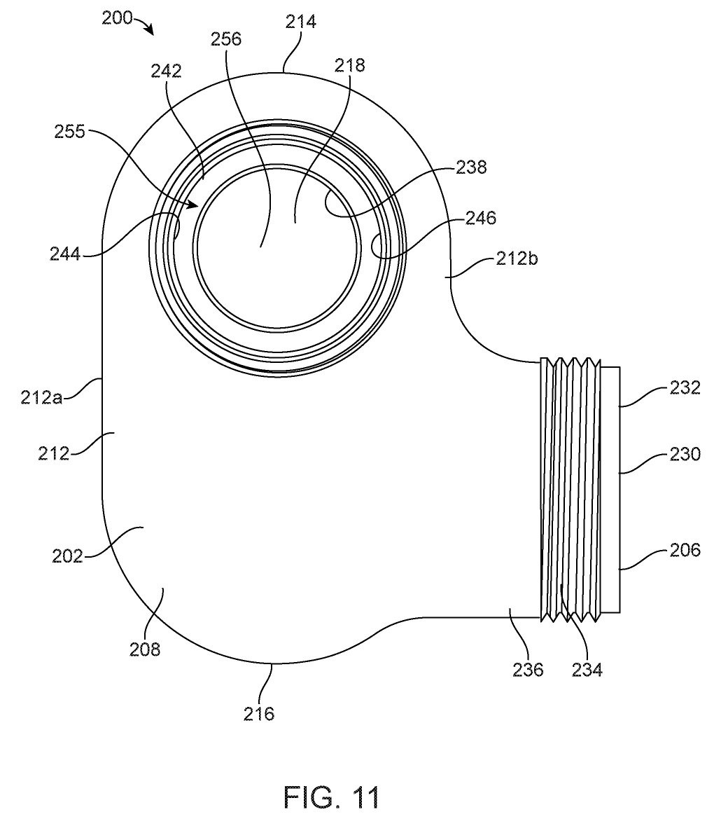

FIG. 11 shows the offset control stop 200, which includes the body 202 and an outlet port 206 of FIG. 10. The body 202 including the front wall 208, the side wall 212, the top end 214, and the bottom end 216. The outlet port 206 includes the threaded opening 230, the rim 232, and threads 234 on the external surface 236 of the threaded opening 230. The outlet port 206 is offset 1.5 inches lower than the center of the threaded opening 238 of the front wall 208. Additionally, the outlet port 206 is a right-hand offset on a second side 212b of side wall 212. The front wall 208 includes the threaded opening 238 for receiving the stop mechanism 240. The threaded opening 238 includes the threads 242 on the internal surface 244. The threaded opening 238 further includes a sealing surface 246 to meet with the seal 248 of the stop mechanism 240. The body 202 includes a flow chamber 218 connecting the outlet port 206, inlet port 204 and threaded opening 238.

FIG. 12 shows a right-hand offset control stop 200 of FIG. 10 and similarly demonstrates the components described for FIG. 11.

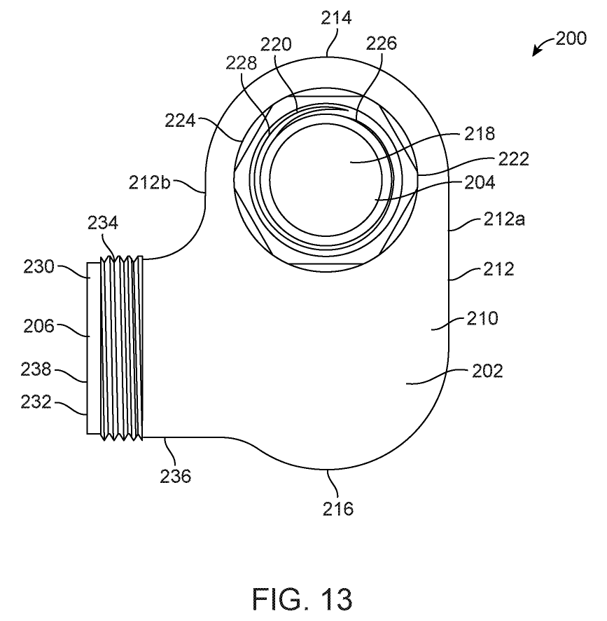

FIG. 13, shows the right-hand offset control stop 200 of FIG. 10, which includes the body 202, an inlet port 204 and an outlet port 206. The body 202 includes the front wall 208, the rear wall 210, the side wall 212, the top end 214, and the bottom end 216. The inlet port 204 includes a threaded opening 224 for receiving the inlet pipe from the flushometer. The inlet port 204 further includes threads 226 on the internal surface 228 of the threaded opening 224. The inlet port 204 forms a seal with the inlet pipe by the tightening mechanism of the nut 222.

The outlet port 206 of FIG. 13 includes the threaded opening 230, the rim 232, threads 234 on the external surface 236 of the threaded opening 230. The outlet port 206 is offset 1.5 inches lower than the center of the threaded opening 238 of the front wall 208. Additionally, the outlet port 206 is a left-hand offset on a first side 212a of side wall 212. The body 202 includes a flow chamber 218 connecting the inlet port 204 and outlet port 206.

FIG. 14 is a top view of the right-hand offset control stop 200 of FIG. 10, which includes a body 202 and an inlet port 204. The body 202 includes the front wall 208, rear wall 210, side wall 212, top end 214 and bottom end 216. The inlet port 204 includes the threaded opening 224 for receiving the inlet pipe from the flushometer. The inlet port 204 further includes threads 226 on the internal surface 228 of the threaded opening 224. The inlet port 204 forms a seal with the inlet pipe by the tightening mechanism of the nut 222.

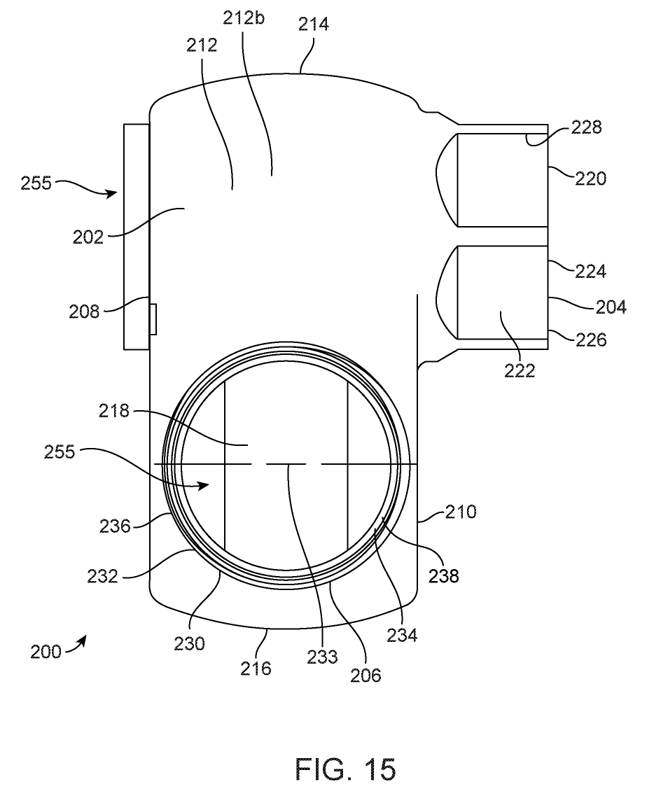

FIG. 15 shows the top view of the right-hand offset control stop 200 of FIG. 10, which includes a body 202, inlet port 204, and outlet port 206. The body 202 includes the front wall 208, rear wall 210, side wall 212, top end 214 and bottom end 216. The inlet port 204 includes the threaded opening 224 for receiving the inlet pipe from the flushometer. The inlet port 204 further includes threads 226 on the internal surface 228 of the threaded opening 224. The inlet port 204 forms a seal with the inlet pipe by the tightening mechanism of the nut 222. The outlet port 206 of FIG. 6 includes the threaded opening 230, the rim 232, and threads 234 on the external surface 236 of the threaded opening 230. In the illustrated embodiment, the outlet port 206 is offset 1.5 inches lower than the center of the threaded opening 238 of the front wall 208. Additionally, the outlet port 206 is a right-hand offset positioned on a first side 212a of side wall 212. The body 202 includes a flow chamber 218 connecting the inlet port 204 and outlet port 206.

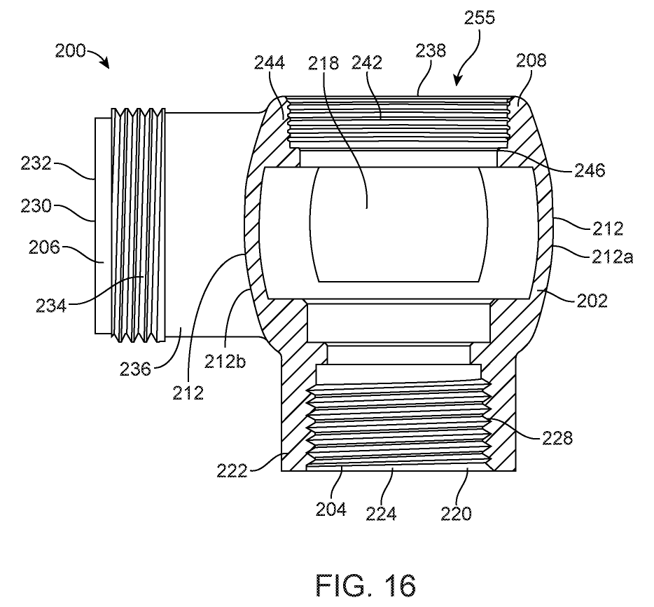

FIG. 16 shows the offset control stop 200 including the body 202, inlet port 204, an outlet port 206 and threaded opening 238 of FIG. 10. The body 202 includes the front wall 208, the side wall 212, the top end 214, and the bottom end 216. The outlet port 206 includes the threaded opening 230, the rim 232, threads 234 on the external surface 236 of the threaded opening 230. The outlet port 206 is offset 1.5 inches lower than the center of the threaded opening 238 of the front wall 208. Additionally, the outlet port 206 is a right-hand offset positioned on a second side 212b of side wall 212. The front wall 208 includes the threaded opening 238 for receiving the stop mechanism 240. The threaded opening 238 includes the threads 242 on the internal surface 244. The threaded opening 238 further includes a sealing surface 246 to meet with the seal 248 of the stop mechanism 240. The body 202 includes a flow chamber 218 connecting the inlet port 204, outlet port 206, and threaded opening 238.

FIG. 17 shows the offset control stop 200 including the body 202 and outlet port 206 of FIG. 10. The body 202 includes the front wall 208, the rear wall 210, and the side wall 212. The outlet port 206 includes the threaded opening 230, the rim 232, threads 234 on the external surface 236 of the threaded opening 230. The outlet port 206 is offset 1.5 inches lower than the center of the threaded opening 238 of the front wall 208. Additionally, the outlet port 206 is a right-hand offset positioned on a second side 212b of side wall 212.

FIG. 18 shows the left-hand offset control stop of FIGS. 10 through 18 with the stop mechanism 240 installed. The stop mechanism 240 contains a seal 248 that is engageable with a valve seat 250. The seal 248 has a convex, non-planar shape. The seal 248 acts to form a tight seal, stopping the flow of fluids in the flow chamber 218. When the stop mechanism 240 is activated, the seal 248 is engaged with the valve seat 150 and the fluid will not flow through the flow chamber 118. When the stop mechanism 140 is deactivated, the seal 148 is disengaged from the valve seat 150 and the fluid will flow through the flow chamber 218. In one instance, the flushometer may be triggered to begin a flush cycle by receiving a signal for a pre-scheduled activity. In another instance, the flushometer may be triggered to begin a flush cycle by receiving a signal from the flushometer’s motion sensor that may detect a user’s proximity to the flushometer. Thus, when the flushometer is triggered to begin a flush cycle, the stop mechanism 240 will be deactivated, the seal 248 disengaging from the valve seat 250 and allowing the fluid to flow through the flow chamber 218.

In an instance when the flushometer is in a waiting stage, such as when a user is detected to be within range of the flushometer’s motion sensor, the stop mechanism 240 will be activated, engaging the seal 248 with the valve seat 250 and stopping the flow of fluid through the flow chamber 218. When the user moves out of range of the flushometer’s motion sensor triggering the flushometer stop mechanism 240 to be deactivated, disengaging the seal 248 from the valve seat 250 and allowing fluid to flow through the flow chamber 218. In another instance, the flushometer may be in a waiting stage, such as for prolonged periods of not being used, the stop mechanism 240 will be activated, engaging the seal 248 with the valve seat 250 and stopping the flow of fluid through the flow chamber 218 until a signal is detected from a pre-scheduled activity, such as a pre-scheduled flush, triggering the stop mechanism 240 to be deactivated, disengaging the seal 248 from the valve seat 250 and allowing fluid to flow through the flow chamber 218.

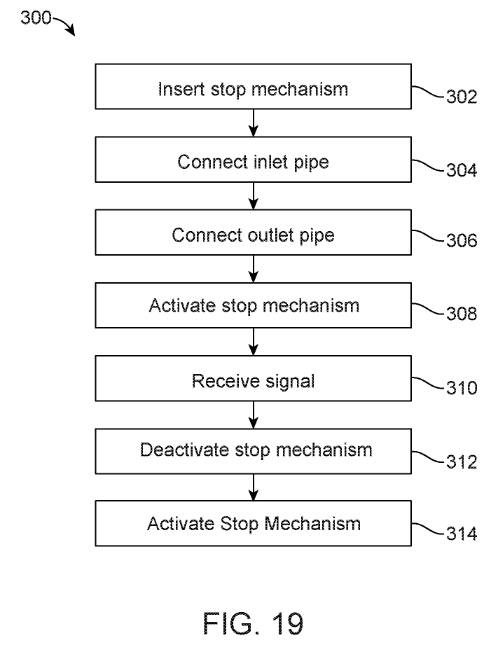

FIG. 19 is a flow diagram of method 300, which describes the method of connecting the left-hand and right-hand offset control stop of FIGS. 1-18 to the flushometer and activating and deactivating the stop mechanism.

In step 302, the stop mechanism 140, 240 is inserted into the threaded opening 138, 238 of the front wall 108, 208.

In step 304, the inlet pipe of the flushometer is connected to the inlet port 104, 204 of the body 102, 202.

In step 306, the outlet pipe of the flushometer is connected to the outlet port 106, 206 of the body 102, 202.

In step 308, the stop mechanism 140, 240 is activated wherein the seal 148, 248 is engaged with the valve seat 150, 250 and the fluid will not flow through the flow chamber 118, 218.

In step 310, in one instance, the flushometer may be triggered to begin a flush cycle such as by receiving a signal for a pre-scheduled activity or by receiving a signal from the flushometer’s motion sensor that may detect a user’s proximity to the flushometer. When a user moves out of range from the flushometer’s motion sensor, the flushometer’s motion sensor sends a signal to trigger a flush cycle.

In step 312, once the signal is received such as either for a pre-scheduled activity or from the flushometer’s motion sensor as described in step 310, the flushometer may be triggered to begin a flush cycle. When the flushometer is triggered to begin a flush cycle, the stop mechanism 140, 240 will be deactivated, the seal 148, 248 disengages from the valve seat 150, 250 and allows the fluid to flow through the flow chamber 118, 218.

In step 314, in one instance, the flushometer may be return to the waiting stage after completing a flush cycle, thus activating the stop mechanism 140, 240, wherein the seal 148, 248 engages with the valve seat 150, 250 and the flow of fluid through the flow chamber 118, 218 is stopped. In another instance, the flushometer may be in a waiting stage, such as when a user is detected to be within range of the flushometer’s motion sensor, the stop mechanism 140, 240 will be activated, engaging the seal 148, 248 with the valve seat 150, 250 and stopping the flow of fluid through the flow chamber 118, 218. In another instance, the flushometer may be in a waiting stage, such as for prolonged periods of not being used, the stop mechanism 140, 240 will be activated, engaging the seal 148, 248 with the valve seat 150, 250 and stopping the flow of fluid through the flow chamber 118, 218 until a signal is detected from a pre-scheduled activity, such as a pre-scheduled flush, triggering the stop mechanism 140, 240 to be deactivated, disengaging the seal 148, 248 from the valve seat 150, 250 and allowing fluid to flow through the flow chamber 118, 218.

It will be understood that certain features and sub combinations are of utility and may be employed without reference to other features and sub combinations. Features described and illustrated with respect to certain embodiments may also be implemented in other embodiments. This is contemplated by and is within the scope of the claims. Since other possible embodiments of the disclosure may be made without departing from the scope thereof, it is understood that examples herein described or shown in the accompanying drawings are to be interpreted as illustrative and are not intended to limit the concepts and principles of the present disclosure. Many changes, modifications, variations and other uses and applications of the illustrated examples will become apparent to those skilled in the art after considering the specification and accompanying drawings. Such changes, modifications, variations and other uses and applications are deemed to be covered by the disclosure.

What is claimed is:

1. An offset control stop comprising:
a body including a front wall having a threaded opening, a rear wall opposite the front wall, and a side wall extending between the front wall and the rear wall;
a flow chamber positioned within the body;
a stop coupled to the threaded opening of the front wall, the stop extending into the flow chamber and operable to control flow of water through the flow chamber;
an inlet port extending along an inlet axis, the inlet port configured to receive fluid from a water supply line; and
an outlet port positioned adjacent to the side wall, the outlet port extending along an outlet axis oriented at an oblique angle relative to the inlet axis, the outlet axis being vertically offset from the inlet port, and the outlet port configured to provide fluid communication between the flow chamber and a flush valve.

2. The offset control stop of claim 1, wherein the outlet port is a right-hand offset.

3. The offset control stop of claim 1, wherein the outlet port is a left-hand offset.

4. The offset control stop of claim 1, wherein the outlet port contains threads on an external surface of the outlet port.

5. The offset control stop of claim 1, wherein the inlet port contains threads on an internal surface of the inlet port.

6. The offset control stop of claim 1, wherein the stop comprises a seal that engages with a sealing surface of the threaded opening of the front wall.

7. The offset control stop of claim 1, wherein the stop engages the seal with the sealing surface to stop the flow of fluid through the flow chamber.

8. The offset control stop of claim 1, wherein the stop disengages the seal with the sealing surface to allow the flow of fluid through the flow chamber.

9. The offset control stop of claim 1, wherein the outlet port is 1.5 inches lower than the inlet port.

10. An offset control stop comprising:
a body includes a front wall having a threaded opening, a rear wall opposite the front wall, a side wall extending between the front wall and the rear wall, and a flow chamber positioned within the body;
a stop coupled to the threaded opening of the front wall and extending into the flow chamber, the stop having a seal engaging a sealing surface of the threaded opening of the front wall, the stop operable to control flow through the flow chamber;
an inlet port positioned adjacent the rear wall of the body, the inlet port extending along an inlet axis, the inlet port configured to receive fluid from a water supply line; and
an outlet port extending along an outlet axis and positioned adjacent to the side wall of the body, the outlet axis oriented at an oblique angle relative to the inlet axis and vertically offset from the inlet port, the outlet port configured to provide fluid communication between the flow chamber and a flush valve.

11. The offset control stop of claim 10, wherein the outlet port is a right-hand offset.

12. The offset control stop of claim 10, wherein the outlet port is a left-hand offset.

13. The offset control stop of claim 10, wherein the outlet port contains threads on an external surface of the outlet port.

14. The offset control stop of claim 10, wherein the inlet port contains threads on an internal surface of the inlet port.

15. The offset control stop of claim 10, wherein the stop engages the seal with the sealing surface to stop the flow of fluid through the flow chamber.

16. The offset control stop of claim 10, wherein the stop disengages the seal with the sealing surface to allow the flow of fluid through the flow chamber.

17. The offset control stop of claim 10, wherein the outlet port is 1.5 inches lower than the inlet port.

18. An offset control stop comprising:
a body including a front wall, a rear wall opposite the front wall, a side wall extending between the front wall and the rear wall, and a flow chamber positioned within the body;
a stop coupled to the front wall extending into the flow chamber, the stop operable to control flow of water through the flow chamber;
an inlet port having an inlet axis, the inlet port configured to receive fluid from a water supply line and an outlet port; and
an outlet port extending along an outlet axis at an angle relative to the inlet axis, the outlet axis vertically offset from the inlet port, the outlet port providing fluid communication between the flow chamber and a flush valve.

19. The offset control stop of claim 18, wherein the stop disengages the seal with the sealing surface to allow the flow of fluid through the flow chamber.

20. The offset control stop of claim 18, wherein the outlet port is 1.5 inches lower than the inlet port.
